(19) United States
(12) Patent Application Publication
(10) Pub. No.: US 2002/0147809 A1
(43) Pub. Date: Oct. 10, 2002

(54) Method and apparatus for selectively displaying layered network diagrams

(76) Inventor: Anders Vinberg, Plandome Manor, NY (US)

Correspondence Address: Calfee, Halter & Griswold LLP, 1650 Fifth Third Center, 21 East State Street, Columbus, OH, 43215-4243, US

(21) Appl. No.: 09/982,301

(22) Filed: Oct. 17, 2001

Related U.S. Application Data
(63) Continuation-in-part of application No. 09/949,101, filed on Sep. 7, 2001.
(60) Provisional application No. 60/241,052, filed on Oct. 17, 2000.

(51) Int. Cl. G06F 15/173; G09G 5/00

(52) U.S. Cl. 709/224; 709/223; 345/736

(57) ABSTRACT

A method for network analysis by presenting a layered network diagram is disclosed. The method includes the steps of receiving input associated with a level of abstraction and extracting information relating to such level of abstraction based on the input. The method also includes the step of filtering network links for display based on the level of abstraction. The filtered network links are displayed to present the layered network diagram. An apparatus for implementing the method is also disclosed.

### RELATED APPLICATIONS

This application claims priority to U.S. Provisional Serial Number 60/241,052 filed Oct. 17, 2000. Further, this application is a Continuation-In-Part of co-pending U.S. Ser. No,. 09/949,101 entitled “Network Management System Using Virtual Reality Techniques to Display and Simulate Navigation to Network Computers” filed Sept. 7, 2001. This application is related to co-pending U.S. Ser. No,. 09/558,897 entitled “Method and Apparatus for Predictively and Graphically Administering a Networked Computer System in a Time Dimension” filed Apr. 26, 2000, and U.S. Ser. No,. 09/559,237 entitled “Method and Apparatus for Maintaining Data Integrity Across Distributed Computer Systems” filed Apr. 26, 2000. Each of the previously mentioned applications is hereby incorporated by reference in its entirety. The concurrently filed U.S. Non-Provisional Application entitled “Method And Apparatus For Displaying 3D State Indicators” is also incorporated herein by reference.

### TECHNICAL FIELD

The disclosed system is in the field of managing networked computer systems that are used in various aspects of a complex business organization that can be monitored by computer technology. More particularly, the disclosed system concerns a method and apparatus for network analysis by selectively displaying layered network diagrams to show the state of one or more links, connections or hardware/software relationships that may exist between components of a network.

### BACKGROUND

Generally, network management systems illustrate the contents and topological structure of a networked system with a display using any one of several visualization techniques such as static 2-D network diagrams, dynamic tree diagrams, or 3-D views. These displays commonly use some type of icon or other symbol to represent the objects or nodes in the networked systems, and lines, pipes or other linear shapes to represent the network links or connections that interconnect the objects or nodes in the networked systems. Various techniques are used to indicate status, traffic volume, performance, or the like, of both the objects or nodes and the links.

Conventional network management systems lay out diagrams based on the networked systems's definition of the network topology at some level of abstraction. For example, a network diagram may represent the physical layer of the network, the electrical interconnections of the wiring, and another diagram may represent the IP layer, the technology underpinning most of today's networks. In many conventional network management systems, the level that the network diagram represents is ill-defined, with each drawn link indicating only that there is at least one form of connection between the objects or nodes. Similarly, in the case of 3-D views, a red status indicator on a network link may indicate a wiring problem, a software error or overload condition in the IP layer, or some unspecified problem detected in some element of the network link. Such poorly specified user interfaces make it hard for the user to understand the structure of the network and to identify problems. Consequently, there is a need for a method and apparatus that presents a network diagram that more accurately illustrates the actual structure of the network and any of its complex, constituent connections.

### SUMMARY

In accordance with the disclosed system, a first method for presenting a layered network diagram in a network analysis system is described. The method includes the steps of receiving input associated with a level of abstraction and determining the level of abstraction based on the input. The method also includes the step of filtering network links for display based on the level of abstraction. The method further includes the step of displaying the filtered network links to present a layered network diagram.

In accordance with the described system, a second method for presenting a layered network diagram on a visualization workstation is also described The second method includes the step of storing in an object repository, at least one object representing a link or connection between components of a network. The method also includes the steps of receiving a request to present the network topology represented by the at least one object in the object repository and receiving input associated with a level of abstraction.

A step of determining the level of abstraction is performed based on the input. The method further includes filtering the objects based on the level of abstraction. The filtered objects are displayed to present the layered network diagram.

The objects, features and advantages of the disclosed method and system are readily apparent from the following description of the preferred embodiments when taken in connection with the accompanying drawings.

### BRIEF DESCRIPTION OF THE DRAWINGS

For a more complete understanding of the disclosed system and the advantages thereof, reference is now made to the following description taken in conjunction with the accompanying drawings in which like reference numbers indicate like features and wherein:

FIG. 1 illustrates a system according to a preferred embodiment of the present system;

FIG. 2A illustrates a display of the representation of a networked computer system;

FIG. 2B illustrates a display of the representation of a networked computer system according to a first embodiment of the present system;

FIG. 2C illustrates a display of the representation of a networked computer system according to a second embodiment of the present system;

FIG. 2D illustrates a display of the representation of a networked computer system according to a third embodiment of the present system;

FIG. 3-4 are flow diagrams that show two stages of a preferred method practiced with the present system; and

FIG. 5 illustrates a user interface control panel for selection of links according to a preferred embodiment of the present system.

### DETAILED DESCRIPTION

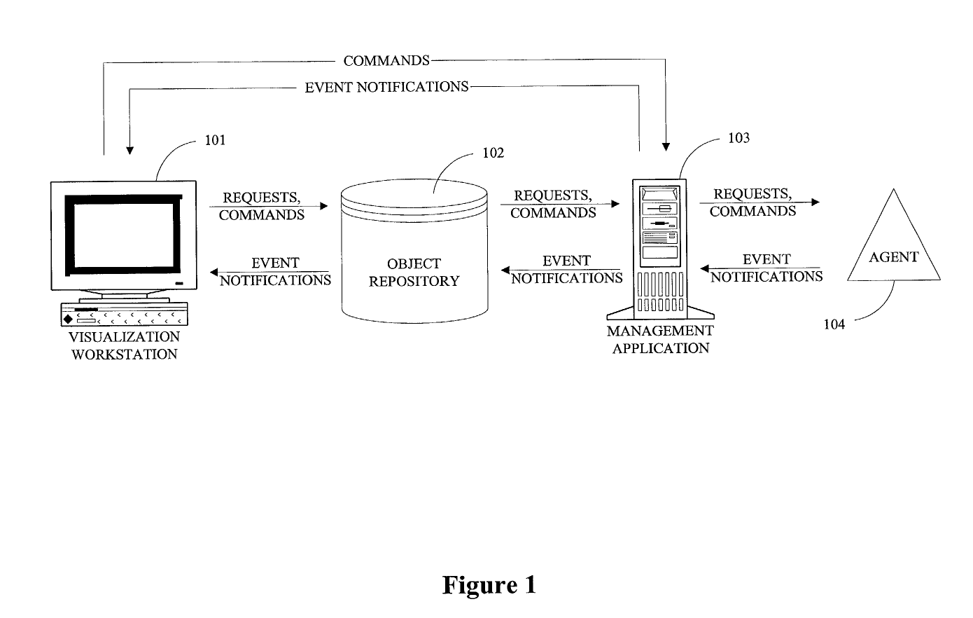

The various components that comprise a preferred embodiment of the disclosed network analysis system are shown in FIG. 1. The system includes one or more of a visualization workstation 101, an object repository 102, one or more management applications 103, and one or more agents 104 associated with each such management application. The visualization workstation 101 interacts primarily with the object repository 102. Workstation 101 requests information from and sends commands to repository 102. Workstation 101 gets notification of events such as status change or object additions from repository 102.

The repository 102 in turn gets this information from the various management subsystems 103, which are fed by agents 104 associated with the managed systems. One architectural consideration of the present system is that in normal operation, the visualization workstation 101 preferably interacts with the object repository 102. This minimizes network traffic, optimizes the performance of the rendering of the workstation 101, and minimizes the interconnectivity between the visualization workstation 101 and the multitude of management subsystems and agents existing in practical networks.

Preferably, the management system is based on some type of store, preferably the object repository 102, that holds the description of the structure of the network. This can include the momentary state, load, and performance of the network and the systems. This store may or may not be persistent, it may be populated with a manual process, or with an automatic discovery utility.

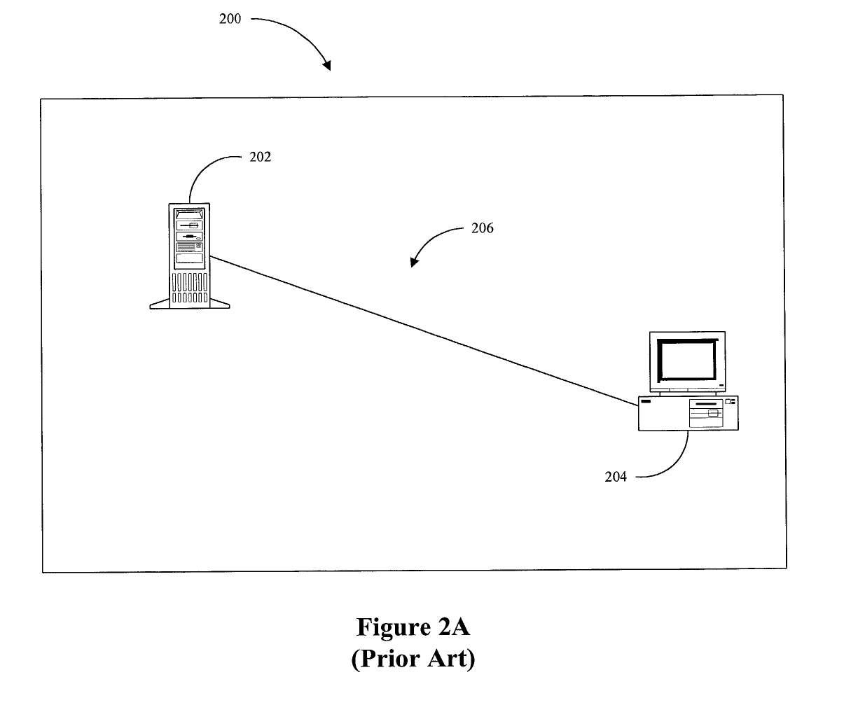

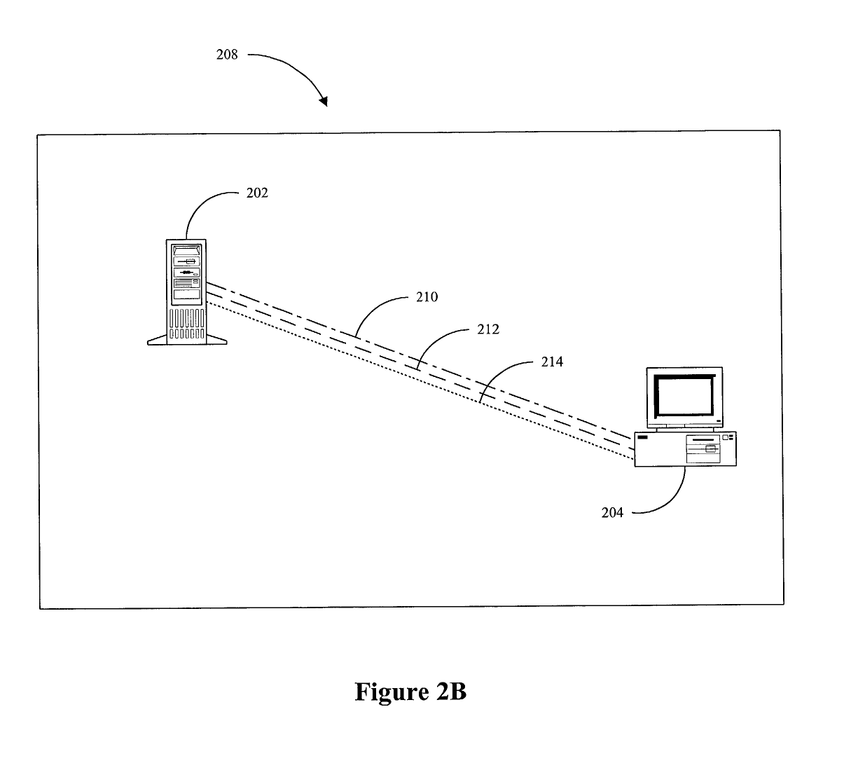

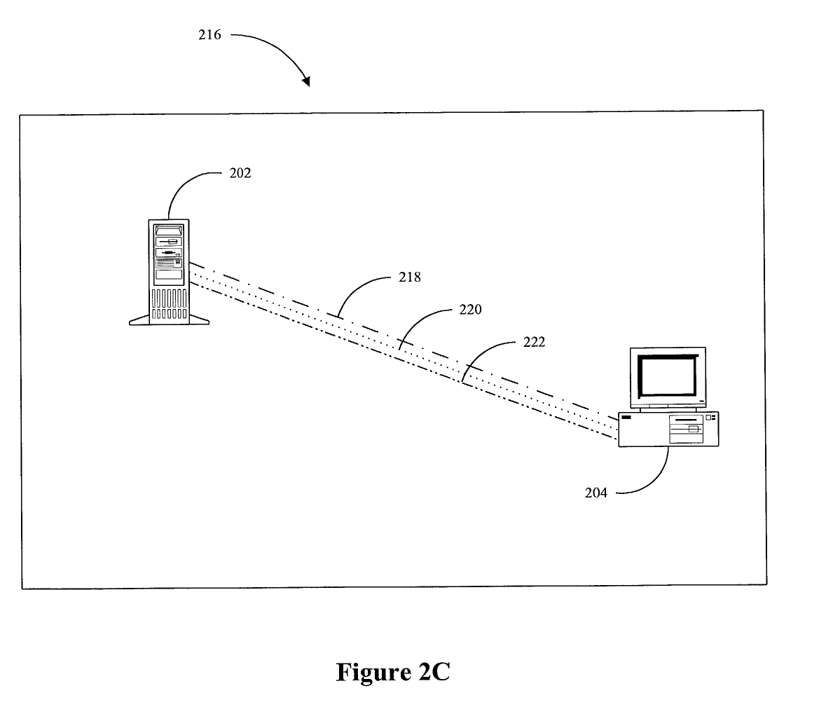

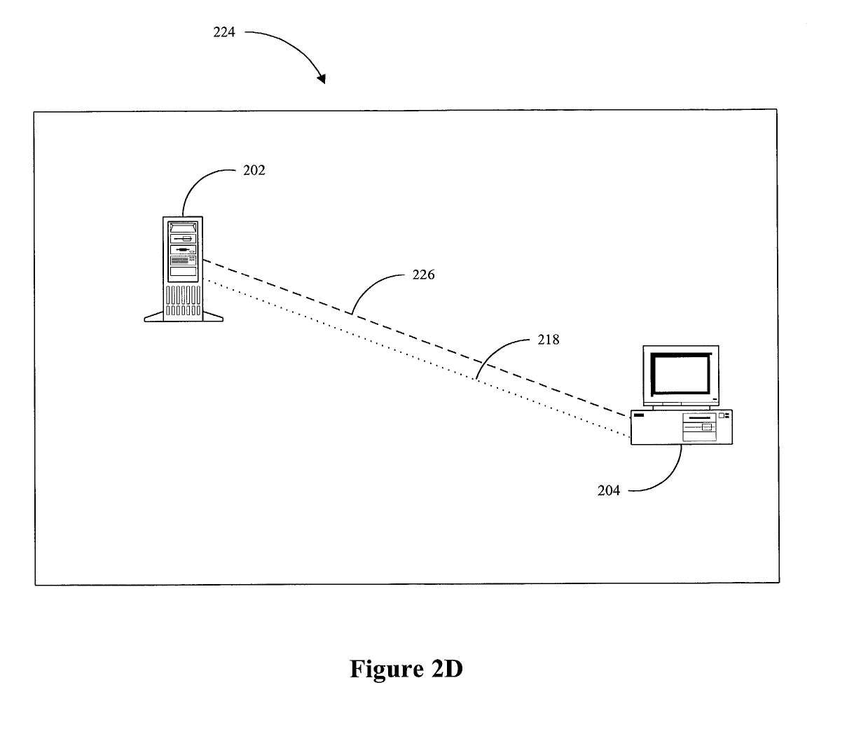

Turning now turn to FIG. 2A, there is illustrated a typical network topology user display 200 showing the representation of a server 202 and a workstation 204 depicted visually as icons and stored as objects within repository 102. A link 206 connects server 202 and workstation 204 indicating at least one physical or logical relationship between the server and the workstation. Given the depiction of a single link 206 between the server 202 and the workstation 204, and the number of ways that server 202 and workstation 204 could be related, link 206 fails to provide meaningful information.

Turning now to FIG. 2B, there is illustrated a preferred network topology user display 208 showing a more detailed connection between server 202 and workstation 204. User display 208 selectively depicts the network topology represented in repository 102. Display 208 provides additional information relating to the link between server 202 and workstation 204. Display 208 selectively presents the network topology according to a particular level of abstraction. In the case of display 208, individual links 210, 212 and 214 are depicted which represent the levels of an industry-standard “stack” representation of the network such as an Open System Interconnection (“OSI”) stack, specifically the network 210, transport 212, and application 214 layers are depicted.

The network layer represents the services in the OSI protocol stack that provide internetworking for a communications session. The transport layer represents the services in the OSI protocol stack that provide end-to-end management of the communications session. The Application layer represents the software in the OSI protocol stack that provides the starting point of the communications session. Displaying separate links for specific layers of a stack enables the user to more accurately determine the state of the relationship between any two network nodes.

Turning now to FIG. 2C, there is illustrated an alternate network topology user display 210 showing a more detailed connection between server 202 and workstation 204 according to a different level of abstraction. User display 210 selectively depicts the network topology represented in repository 102 by displaying individual links 218, 220 and 222. In this alternative embodiment, the individual links 218, 220 and 222 represent the specific protocols running on the various levels of the “stack” representation of the network, namely Internet Protocol (“IP” ), Transmission Control Protocol (“TCP”) and File Transfer Protocol (“FTP”), respectively.

Turning now to FIG. 2D, there is illustrated another alternate network topology user display 224 showing a detailed connection between server 202 and workstation 204 according to yet a different level of abstraction. User display 224 selectively depicts the network topology represented in repository 102 by displaying individual links 226 and 218. In this alternative embodiment, the individual links 226 and 218 represent the different types of specific protocols running on a particular layer. Links 226 and 218 represent Hypertext Transfer Protocol (“HTTP”) and FTP, respectively, both of which run in the application layer.

Accordingly, the individual links between two network components may represent whatever abstraction layer is of interest to the user and the management applications, regardless of the logical definitions or relationships of such layers. Although the links of FIGS. 2A-2D are depicted as various two-dimensional dotted, dashed and solid lines, this is only one way to implement the method. Of course, links of various colors, shapes, sizes, animations and dimensions could be used to convey information pertaining to any relationship between two network components.

In a preferred embodiment, the various links that connect a specific pair of network components or objects in a user display are related in an order that reflects the foundation or containment hierarchy of the stack of abstraction layers. For example, the order of links displayed in FIG. 2C indicates that FTP 218 runs on top of TCP 220 which runs on top of IP 222. In alternative preferred embodiments the various links that connect a specific pair of network components objects in a user display are related in a structure that indicates that they are at the same logical layer, for example FIG. 2D indicates that FTP 218 and HTTP 226 are both in the application layer. In still other preferred embodiments, the various links that connect a specific pair of network components or objects in a user display are related in a structure that indicates dependencies among them. For example, a user display may provide a display that illustrates that both FTP and HTTP are dependent on TCP, and all three as well as LU 6.2 are dependent on a physical connection.

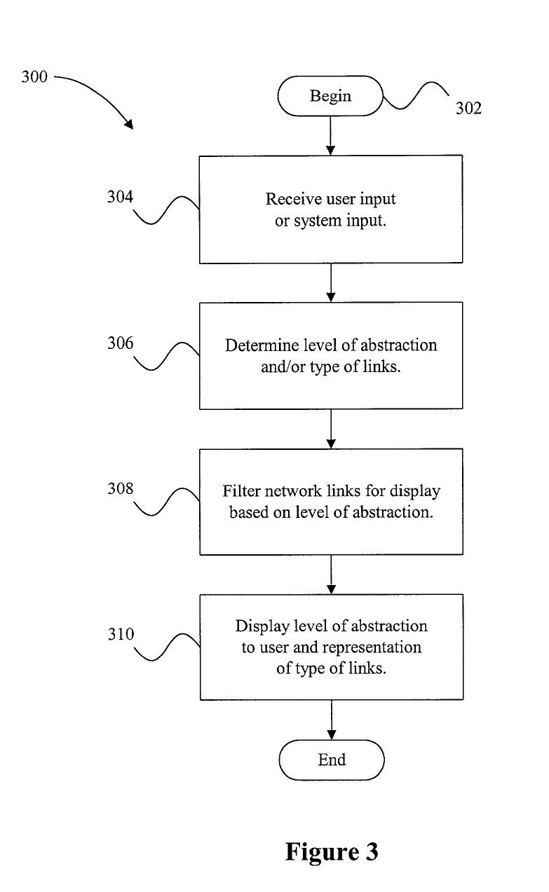

All of these variations can be controlled by the method 300 shown in FIG. 3. After starting at step 302, an input or signal is received from the user or system at 304. The input is preferably a specific request to identify the level of abstraction or type of links or connections of interest to the user. Alternatively, the input could be other data such as a User ID or a System ID, for example, from which the system can determine the user's preferred links to display.

The method then determines or correlates a level of abstraction and/or a type of link at 306 based on the signal received at 304. After the determination or correlation is made at 306, the method filters the network links according to the level of abstraction at 308. The method then outputs a display for the user at 310 showing the level of abstraction and a representation of the type of links.

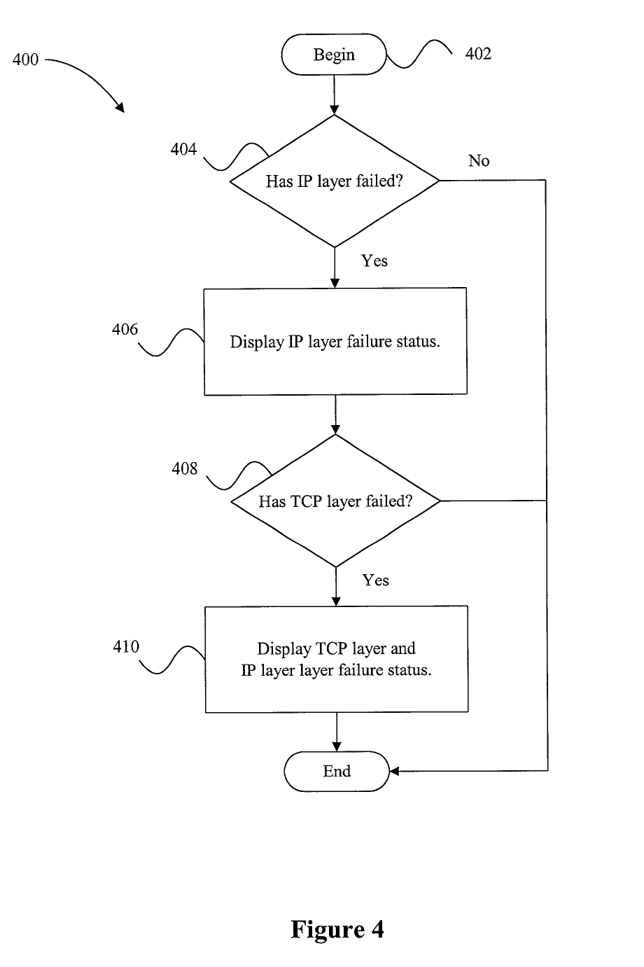

Turning to FIG. 4, a flow chart 400 showing part of a method according to a preferred embodiment of the present system is shown. Preferably, the filtering of network links includes identifying any network link that would be of interest to the user regardless of the level of abstraction, such as a relevant propagated failure.

By way of example, a system may employ a propagation engine that propagates a state up along an inclusion hierarchy or along dependency relationships. The propagation engine operates independently for all the types of links, following all the inclusion and dependency relationships that are relevant for such a propagation engine.

The illustrated propagation engine will cause an TCP failure to be reflected in an IP link, even if only the IP link is selected to be displayed. The preferred method begins at 402 At 404, a failure in the IP layer is tested. If the IP layer has failed, an IP failure status is displayed at 406. The propagation engine then proceeds to determine whether an TCP layer failure has occurred at 408. This determination is necessary because the IP layer is considered to contain TCP. Consequently, a failure in the TCP layer would affect both the TCP layer and the IP layer. At 408, if a TCP layer failure has occurred, the propagation engine displays both an IP layer failure and a TCP layer failure at 410. Likewise, since TCP is dependent on IP to operate correctly, a failure in the IP layer should propagate to the TCP layer as well, making the system show a deduced failure status even if only the TCP layer is displayed.

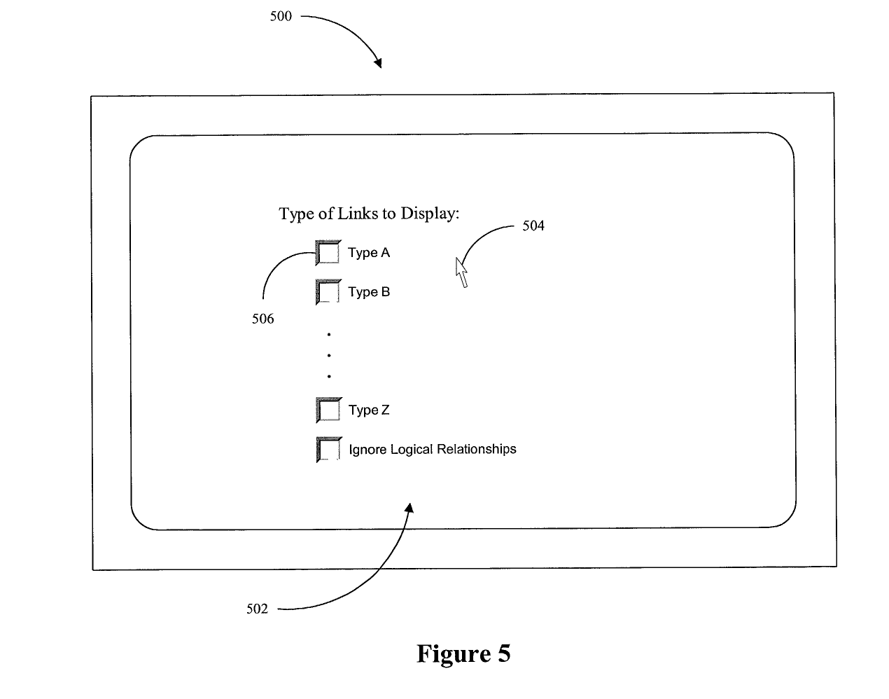

One configuration for a preferred user interface 500, which is preferably within display 200, provides a control panel 502, preferably similar to that shown in FIG. 5, that allows the user to select which types of links are represented in the display. It is to be appreciated, alternative preferred embodiments include similar functioning user interfaces. The selection is preferably based partially on the method shown in FIG. 3. This user interface 500, and associated software, reflects the logical relationships among the various types of links 206, illustrating the standard stack structure or some other structure that is of interest in the particular illustration. The user interface 500 permits the selection of several types of links 206 to be included, regardless of their logical relationships. This is done by allowing a user to point and click the cursor 504 over a box 506 indicating a particular type of link. It is to be appreciated, alternative preferred embodiments include other user control devices.

The user interface 500 preferably displays the state, load, and performance indicators for the selected layers only. The user interface 500 utilizes a “preferences” dialog technique, for selecting which types of indicators should be allowed to override the selected display type, based on type of link, importance of the link or end-nodes of the link, severity of state, urgency or risk of prediction, or other contextual indicator.

Other preferred systems can provide user interfaces that include other techniques for selecting what information should be displayed, filtering based on the class or importance of the object, severity of status, membership in business process, and other properties. In accordance with alternative preferred embodiments of the present system, the system cooperates with such context-based filtering, allowing the user to direct for, example, that the display should include only those systems and links that are part of order processing and handle IP traffic.

In summary, a preferred embodiment discloses a method and apparatus that allow for network analysis by a representation of the structure, state, load, or performance of the links and connections between components of a network by methods including using layered network diagrams. This representation is customizable allowing the user to easily and quickly select what aspect of the links comprising a network to view.

Accordingly, it is to be understood that the drawings and description in this disclosure are proffered to facilitate comprehension of the system, and should not be construed to limit the scope thereof. It should be understood that various changes, substitutions and alterations can be made without departing from the spirit and scope of the system.

What is claimed is:

1. A method for analyzing links between components of a computer system, comprising:
receiving input associated with a level of abstraction;
determining the level of abstraction based on the input;
filtering network links for display based on the level of abstraction; and
displaying the filtered network links to present a layered network diagram.

2. The method of claim 1, wherein the input is a user identification.

3. The method of claim 1, wherein the level of abstraction represents at least one protocol.

4. The method of claim 1, wherein each displayed network link represents a layer of an industry standard stack.

5. The method of claim 4, wherein the layer of the industry standard stack is selected from the group consisting of the layers of an Open System Interconnection (OSI) protocol stack.

6. The method of claim 1, wherein each network link represents a protocol.

7. The method of claim 6, wherein the protocol is selected from the group consisting of Internet Protocol (IP), Transmission Control Protocol (TCP), File Transfer Protocol (FTP) and Hypertext Transfer Protocol (HTTP).

8. The method of claim 1, wherein filtering includes identifying any network link that represents a relevant propagated failure regardless of the level of abstraction.

9. The method of claim 1, wherein displaying includes displaying a three dimensional representation of the link.

10. A method for network analysis by presenting a layered network diagram on a visualization workstation, comprising:
storing in an object repository, at least one object representing a link between components of a network;
receiving a request to present the network topology represented by the at least one object in the object repository;
receiving input associated with a level of abstraction;
determining the level of abstraction based on the input;
filtering the at least one object based on the level of abstraction; and
displaying the at least one filtered objects to present a layered network diagram.

11. The method of claim 10, wherein the level of abstraction limits the presentation to at least one protocol.

12. The method of claim 10, wherein the displayed objects represent a layer of an industry standard stack.

13. The method of claim 12, wherein the layer of the industry standard stack is selected from the group consisting of the layers of an Open System Interconnection (OSI) protocol stack.

14. The method of claim 10, wherein each displayed object represents a protocol.

15. The method of claim 14, wherein the protocol is selected from the group consisting of Internet Protocol (IP), Transmission Control Protocol (TCP), File Transfer Protocol (FTP) and Hypertext Transfer Protocol (HTTP).

16. The method of claim 10, wherein filtering includes identifying any object that represents a relevant propagated failure regardless of the level of abstraction.

17. The method of claim 10, wherein displaying includes displaying a three dimensional representation of the at least one object.

18. An apparatus for analyzing links between components of a computer system, comprising:
a processor;
a memory connected to said processor storing a program to control the operation of said processor;
the processor operative with the program in the memory to:
receive input associated with a level of abstraction;
determine the level of abstraction based on the input;
filter network links for display based on the level of abstraction; and
display the filtered network links to present a layered network diagram.

19. An apparatus for network analysis by presenting a layered network diagram on a visualization workstation, comprising:
a processor;
a memory connected to said processor storing a program to control the operation of said processor;
the processor operative with the program in the memory to:
store in an object repository, at least one object representing a link between components of a network;
receive a request to present the network topology represented by the at least one object in the object repository;
receive input associated with a level of abstraction;
determine the level of abstraction based on the input;
filter the at least one object based on the level of abstraction; and
display the at least one filtered objects to present a layered network diagram.

20. An apparatus for analyzing links between components of a computer system, comprising:
means for receiving input associated with a level of abstraction;
means for determining the level of abstraction based on the input;
means for filtering network links for display based on the level of abstraction; and
means for displaying the filtered network links to present a layered network diagram.

21. A apparatus for network analysis by presenting a layered network diagram on a visualization workstation, comprising:
means for storing in an object repository, at least one object representing a link between components of a network;
means for receiving a request to present the network topology represented by the at least one object in the object repository;
means for receiving input associated with a level of abstraction;
means for determining the level of abstraction based on the input;
means for filtering the at least one object based on the level of abstraction; and
means for displaying the at least one filtered objects to present a layered network diagram.

22. A computer-readable storage medium encoded with processing instructions for implementing a method for analyzing links between components of a computer system, the processing instructions for directing a computer to perform the steps of:
receiving input associated with a level of abstraction;
determining the level of abstraction based on the input;
filtering network links for display based on the level of abstraction; and
displaying the filtered network links to present a layered network diagram.

23. A computer-readable storage medium encoded with processing instructions for implementing a method for network analysis by presenting a layered network diagram on a visualization workstation, the processing instructions for directing a computer to perform the steps of:
storing in an object repository, at least one object representing a link between components of a network;
receiving a request to present the network topology represented by the at least one object in the object repository;
receiving input associated with a level of abstraction;
determining the level of abstraction based on the input;
filtering the at least one object based on the level of abstraction; and displaying the at least one filtered objects to present a layered network diagram.
